(19) United States
(12) Patent Application Publication
(10) Pub. No.: US 2024/0403884 A1
(43) Pub. Date: Dec. 5, 2024

(54) SYSTEM AND METHOD FOR PROCESSING INFORMATION ASSOCIATED WITH SPECIFIED FINANCE-RELATED ACTIVITIES

(71) Applicant: Fintel Technologies, Inc., New York, NY (US)

(72) Inventors: Matthew Adam Rosen, New York, NY (US); Justin Paul Caulfield, Northpoint, NY (US)

(73) Assignee: Fintel Technologies, Inc., New York, NY (US)

(21) Appl. No.: 18/649,667

(22) Filed: Apr. 29, 2024

Related U.S. Application Data
(63) Continuation of application No. 14/000,347, filed on Nov. 4, 2013.
(60) Provisional application No. 61/445,014, filed on Feb. 21, 2011.

(51) Int. Cl. G06Q 20/40; G06Q 40/00

(52) U.S. Cl. CPC G06Q 20/4016; G06Q 40/00

(57) ABSTRACT

The present invention is directed to a system for storage, evaluation, and transmission of information related to suspicious underlying activity that in turn is related to financial transactions comprising: (1) a secure data processing center, wherein the secure data processing center receives, stores, and transmits reports related to suspicious underlying activity that in turn is related to financial transactions, the secure data processing center including therein a storage mechanism for the reports including a memory; (2) at least one terminal in communication with the secure data processing center, wherein the terminal transmits and receives the reports related to suspicious underlying activity that in turn is related to financial transactions; and (3) means for authenticating and controlling communication between the at least one terminal and the secure data processing center; wherein the storage of the reports in the secure data processing center modifies the state of the secure data processing center in terms of the physical state of as the memory as the result of the storage of the reports. The invention further encompasses the use of the system to post, communicate, and analyze information related to such financial transactions.

### CROSS-REFERENCE

This application is a continuation of U.S. patent application Ser. No. 14/000,347, filed Nov. 4, 2013, which is a § 371 national phase entry of international application no. PCT/US2012/025860, filed Feb. 21, 2012, and which claims the benefit of U.S. Provisional Patent Application Ser. No. 61/445,014 by J. Paul Caulfield et al., titled “Methods to Acquire, Share and Analyze Information Related to Fraud, Money Laundering, Terrorist Financing and Other Suspicious Underlying Activities,” filed on Feb. 21, 2011, the contents of which are incorporated herein by this reference.

### FIELD OF THE INVENTION

This invention relates to fraud detection and prevention, anti-money laundering (AML) and economic sanctions compliance, and the counter financing of terrorism (CFT) efforts within the financial services industry. Specifically, the invention provides methods and systems to support increased, efficient, and more robust information sharing. Aspects of the invention rely on the safe harbor provision of USA PATRIOT Act § 314(b) that allows financial institutions to freely share information about fraud, money laundering, terrorist financing and other specified unlawful activities (SUAs) without fear of exposing the institution to civil liability (See FinCEN Guidance, Jun. 16, 2009, Guidance on the Scope of Permissible Information Sharing Covered by Section 314(b) Safe Harbor of the USA PATRIOT Act; see also 18 U.S.C. §§ 1956 and 1957 for list of SUAs, which includes a variety of frauds and other criminal activities such as murder, kidnapping, the destruction of property and other violent crimes). Similar statutes and regulations exist in other jurisdictions concerned with money laundering, financial fraud, and financing of terrorism.

### BACKGROUND OF THE INVENTION

It is estimated that globally $2 trillion in illicit money annually flows through the financial system, approximately 3-4% of global GDP (The World Bank; Illicit Money: Can it be Stopped?, Raymond W. Baker and Eva Joly, New York Review of Books, Dec. 3, 2009). Such funds are derived from all facets of crime and terrorism—proceeds of theft, including identity theft, check kiting, product counterfeiting, smuggling, bribery, corruption, drug trafficking, tax evasion and fraud, as well as money being moved to finance acts of terrorism. This problem is getting more difficult to eradicate and control as the financial industry becomes more complex and global, and illicit actors advance more intricate methods that often exploit technology. Increasingly, preventing fraud, detecting money laundering, complying with economic sanctions, and stopping terror financing cut across internal departments and the sector as a whole.

Strong efforts by the financial industry to prevent and detect the flow of illicit funds have long been recognized as essential. The public's confidence in the stability of the financial system is often compromised as a result of illicit actions that result in negative publicity and potential legal liability (Bank of International Settlements, Prevention of Criminal Use of the Banking System for Money-Laundering, December 1988). Moreover, in addition to compliance with laws that require financial institutions to detect and report to the government suspicious activity, a business case exists for proactive monitoring of the system. When bad actors abuse the financial system, “institutions lay themselves open to direct losses from fraud,” through identity theft, “negligence in screening undesirable customers or where the integrity of their own officers has been undermined through association with criminals.” (Ibid.).

As for industry-wide collaborative information sharing, financial institutions are generally precluded from disclosing customer information and always face legal and reputational risks anytime they disclose otherwise sensitive information outside their organization. Following Sep. 11, 2001, and passage of the USA PATRIOT Act, financial institutions and associations of financial institutions were provided, under section 314(b), a “safe harbor” exception in which they could voluntarily share information with one another. The exception was narrowly drawn at first: financial institutions and associations of financial institutions could share information for the purpose of “identifying and, where appropriate, reporting activities that . . . may involve possible terrorist activity or money laundering.”

To participate, financial institutions and associations of financial institutions must submit a yearly notice of intent with the Department of Treasury's Financial Crimes Enforcement Network (FinCEN). A financial institution or association of financial institutions must take “reasonable steps” to verify that the other financial institution or association of financial institutions with which it intends to share information is also a registered 314(b) participant (USA Patriot Act § 314(b) and 31 C.F.R. § 103.110). Presently, this is done on an ad hoc basis through inquiry with FinCEN or with the other financial institution or association of financial institutions directly.

Participating financial institutions or association of financial institutions must establish and maintain procedures to protect the security and confidentiality of their shared information. Compliance with section 501 of the Gramm-Leach-Bliley Act (15 USC 6801) is sufficient.

At the outset, financial institutions found it difficult to differentiate between the narrow exclusion of sharing information related to terrorist activity and money laundering versus discussions related to financial crimes not covered by 314(b). In response, FinCEN clarified (and broadened) the exception to include information related to a specified unlawful activity (SUA) that had connection to possible terrorist activity or money laundering and largely included a wide variety of fraudulent activities. When information is shared for these purposes, financial institutions and associations of financial institutions are also shielded from liability from any party identified in the shared information.

Since passage of the USA PATRIOT Act, financial institutions have invested heavily in the development of internal systems to bolster their ability detect and report suspicious activity. The result has been a massive increase in the amount of data created in the effort to comply with government regulations. In 2009, for example, over 1.2 million suspicious activity reports (SARs) were filed with FinCEN—six times the number of SARs filed in 2001 (FinCEN, The SAR Activity Review—By the Numbers, June 2010). Financial institutions spend billions annually on AML and CFT compliance (“Chasing Dirty Money: The Fight Against Money Laundering,” Peter Reuter and Edward M. Thuman, November 2004; The Economist, Corning Clean Banks must fight money-laundering, but they need some help, Oct. 14, 2004). Studies estimate that at top financial institutions compliance costs average 3.69% of net income (ABA Bank Compliance May/June 2009 citing Deloitte & Touche's Deloitte Center for Banking Solutions 2007 Survey).

Despite this investment, information valuable to AML, CFT and anti-fraud efforts remain siloed within different departments of many financial institutions. AML and CFT compliance and fraud detection at most financial institutions remain segregated, even though the functions required to detect and prevent such activity as well as comply with SAR requirements are the same for all three. For global institutions, another difficulty exists, both legally and practically, the ability to share information across jurisdictions amongst affiliates.

The failure to adequately comply with AML regulations can be devastating to an institution's reputation and to bottom-line concerns. In 2010, record fines were levied for AML deficiencies. In recent years, FinCEN guidance has promoted greater information sharing and clarified that this sharing may include suspicions of fraud and that it be similarly protected under the safe harbor provision. However, institutions have commented that existing procedures for participating in the program do not establish or promote a readily secure, consistent and efficient manner in which to exchange such information.

Therefore, there is a need for an improved system to identify, track and monitor improper financial activity, such as financial activity associated with criminal activity and support of terrorism, within a financial institution. The improved system should provide increased, efficient, and more robust information sharing among officials and employees of the financial institution and enable officials and employees to detect patterns of transactions associated with suspicious underlying activities.

### SUMMARY OF THE INVENTION

The invention is based on the need for a solution that will synthesize and holistically analyze information regarding illicit actors utilizing the financial system to commit fraud, launder the proceeds of crime, evade economic sanctions, finance terrorism or commit some other SUA. The invention is a secure, electronic platform that enables, facilitates and encourages financial institutions to share information with other financial institutions in full compliance with applicable laws. The invention enables greater information sharing both internally across jurisdictions and business lines, and externally amongst peer institutions.

The invention promotes greater information sharing in separate and related ways. The first method involves the voluntary contribution and accessibility of information to a secure data processing center. Specifically, the system enables users to populate uniform data templates (UDT) and securely transmit the information to the central repository over the Internet, including making the information accessible to the central clearinghouse through secure means whereupon ownership and control of the data is maintained by the user.

Second, the invention allows users to identify and contact other individuals either within their own institution or a non-affiliated institution that may have an interest in sharing information. This one-stop “identify and communicate” method is the starting point for users of the system to share information directly, as well as for users to contribute information to the central repository. Purposely, the system enables users to identify other financial institution interested in sharing information pursuant to § 314(b) without an ongoing need to confirm eligibility with FinCEN. The system maintains an updated list of such eligible institutions and their designated points of contact. Moreover, the system includes the capacity to identify whether a given series of communications will be covered under the safe harbor provision of § 314(b) based on user-generated answers to questions posed by the application.

An improved system for storage, evaluation, and transmission of information related to suspicious underlying activity that in turn is related to financial transactions comprises:
(1) a secure data processing center, wherein the secure data processing center accesses, receives, stores, and transmits information related to suspicious underlying activity that in turn is related to financial transactions, the secure data processing center including therein an auditing and retrieval mechanism for the information including a memory;
(2) at least one terminal or server in communication with the secure data processing center, wherein the terminal or server transmits and receives the information related to suspicious underlying activity that in turn is related to financial transactions; and
(3) means for authenticating and controlling communication between the at least one terminal or server and the secure data processing center; wherein the storage of the information in the secure data processing center modifies the state of the secure data processing center in terms of the physical state of the memory as the result of the storage of the information.

The means for authenticating and controlling communication can incorporate a wired or wireless connection. The means for authenticating and controlling communication can incorporate encryption. Typically, the means for authenticating and controlling communication requires entry of both a username and a password prior to commencement of communication. The means for authenticating and controlling communication can be programmed to require that passwords be of a specified strength and reject passwords that are below that strength, or can be programmed to require that passwords be changed at a specified interval. The means for authenticating and controlling communication can enable users to various rights, or restricting certain rights, such as the ability to make available or post information, send messages and view analytics generated by the system.

The system can verify that a financial institution associated with a terminal is an active participant in a statutory information sharing program intended to identify and potentially report money laundering and terrorist financing activity. The verification can involve: (i) entry of a legal agreement appointing an entity, association of financial institutions, or other financial institution controlling and/or servicing the system as an agent of the initial financial institution for the purposes of the statutory program intended to identify and potentially report money laundering and terrorist financing activity; and (ii) matching the name of the initial financial institution identified in the legal agreement with an internal list of registered institutions and their points of contact participating in the statutory program intended to identify and potentially report money laundering and terrorist financing activity. Typically, once a financial institution and user are verified, the system transfers a user to a dashboard platform employing a graphical user interface. The dashboard platform can enable a user to: (1) make available or post information; (2) message another user; (3) perform due diligence and querying functions; (4) view analytics; (5) view alerts; and (6) prepare reports regarding potentially suspicious and suspicious activity. The graphical user interface can enable a user to make use of a conventional program selected from the group consisting of a word processing program and a program for preparing and manipulating spreadsheets.

The system can generate one or more analytics in real time. The analytics can include at least one analytic selected from the group consisting of reports about the foreign countries suspected of harboring suspicious activity, the types of fraud or money laundering occurring, e.g., mortgage fraud, trade-based money laundering, the use of straw men, or suspicious, unidentifiable beneficiaries, as well as details about the occurrence and frequency of loss generating activity.

The system can generate one or more profiles, and the profiles can be first created based on an individual person or entity name and are evolved as more information is entered or made available. The information included in profiles can be indexed and aggregated. The information included in profiles can be searchable, and the system can provide a secure delivery method for the aggregated information in profiles. The profiles can be accessed through a query and due diligence function. The system can send one or more messages to counterparties within the same financial institution or another financial institution to which the system has access. The system can enable a user to prepare a Suspicious Activity Report for transmittal to a government agency monitoring such activity and have the system also retain the underlying information used to complete the report.

Another aspect of the invention is a method wherein any officer, employee, or agent of a financial institution employs the system of the invention to voluntarily make available or post information concerning an incident of suspected fraud, money laundering, terrorist financing or other specified unlawful activity (SUA) to a secure data processing center.

Yet another aspect of the invention is a method wherein any officer, employee, or agent of a financial institution employs the system of the present invention to voluntarily connect, communicate, and share information concerning suspected fraud, money laundering, terrorist financing and other SUAs, with other officers, employees, or agents of the same financial institution, affiliated financial institutions, or non-affiliated financial institutions, including through the use of real-time interaction methods.

### BRIEF DESCRIPTION OF THE DRAWINGS

These and other features, aspects, and advantages of the present invention will become better understood with reference to the following description, appended claims, and accompanying drawings where:

FIG. 1 is the process by which users initiate log in to the system, including secure encryption, user verification and rights, and system use type and launch. Verification includes determining user's current ability to share information pursuant to USA PATRIOT Act 314(b).

FIG. 2 is an example of a user dashboard including real-time analytical reports based on information provided by multiple users, message inbox, alert notification, and buttons for accessing other platform features.

FIG. 3 is the process for posting or making available information to the Suspicious Data Clearinghouse.

FIGS. 4A, 4B, and 4C collectively illustrate an example template for posting or making available characteristic information to the Suspicious Data Clearinghouse, answering questions to provide a message preview, and evaluate whether the communication will be covered by USA PATRIOT Act section 314(b).

FIG. 5 is an example template for posting or making available specific information and a detailed narrative to the Suspicious Data Clearinghouse.

FIG. 6 is an example profile aggregating information contributed or made available by multiple users, including risk-profile score and assessment.

FIG. 7 is the process for query and due diligence function, including pattern of search results, linked to third-party data, and ability to set alert.

FIG. 8 is the process for messaging recipients internally and externally.

FIG. 9 is the process for using the platform to initiate the filing of Suspicious Activity Reports (SAR) with the government, and simultaneously selecting data for retention by the Suspicious Data Clearinghouse.

FIG. 10 is a block diagram of a system according to the present invention, including a secure data processing center, terminals, and a means for authenticating and controlling communication between the at least one terminal and the secure data processing center.

### DETAILED DESCRIPTION OF THE INVENTION

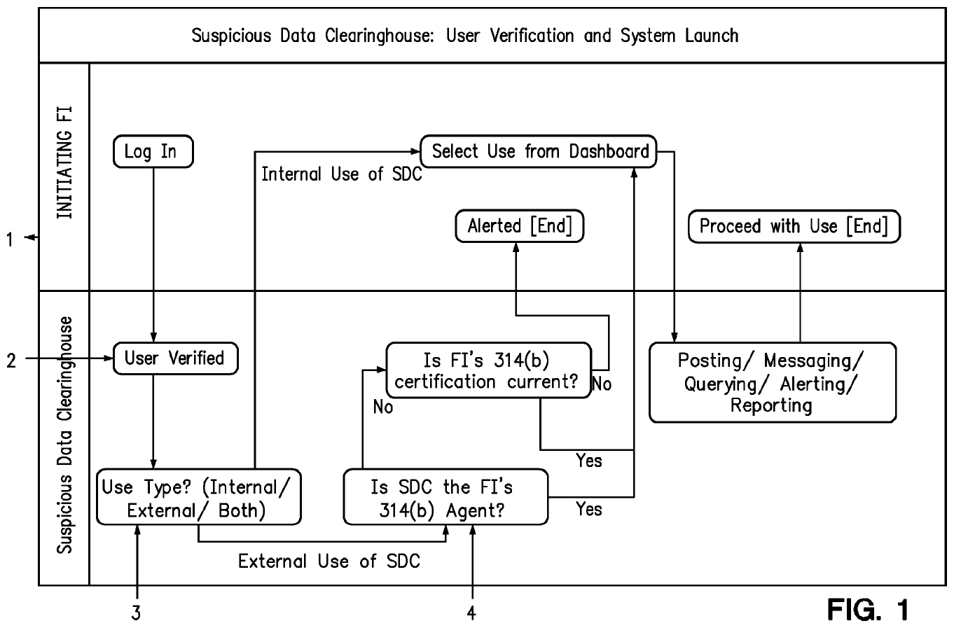

The invention entails multiple methods for sharing information-internally, industrywide, or in combination. All methods begin with secure login and user verification as shown in FIG. 1. Verified users through the financial institutions where they are employed will have a contractual relationship with the Suspicious Data Clearinghouse (SDC). Due to the confidential nature of the information available through the invention, access to the system will be restricted based on user location; suitable encryption techniques will be used. As well, the invention enables each financial institution to create classes of users. As such, the invention enables some users to distribute and post information and messages, while other users can only view analytics.

Additionally, as shown in FIG. 1 if the financial institution is utilizing the platform to share information with non-affiliated institutions, SDC will verify said institution is an active participant in the USA PATRIOT Act section 314(b) information sharing arrangement and that its user is a listed point of contact 4. Verification is accomplished in two steps. First, the institution enters a legal agreement appointing SDC as agent for 314(b) purposes or joining an association of financial institutions affiliated with SDC. Second, SDC matches the financial institution and its appointed user's name against an internal list of registered 314(b) participants that SDC maintains and as provided by FinCEN from time to time. SDC is responsible for ensuring yearly 314(b) notices are filed for all users with which it maintains this agency relationship.

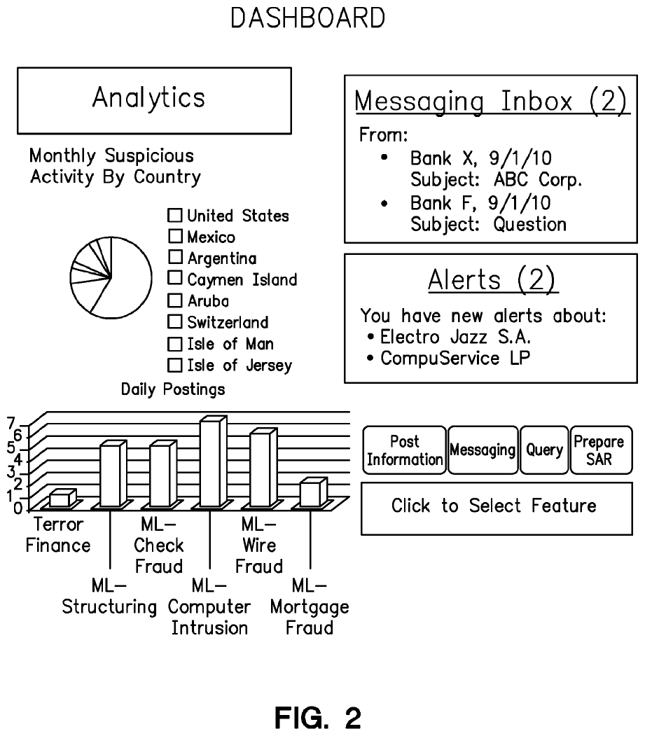

After verification, user is transferred to a dashboard platform, FIG. 2. The dashboard platform enables access to system features, including posting and making information available to other users, messaging, due diligence and querying, analytics, alerts, and suspicious activity report preparation.

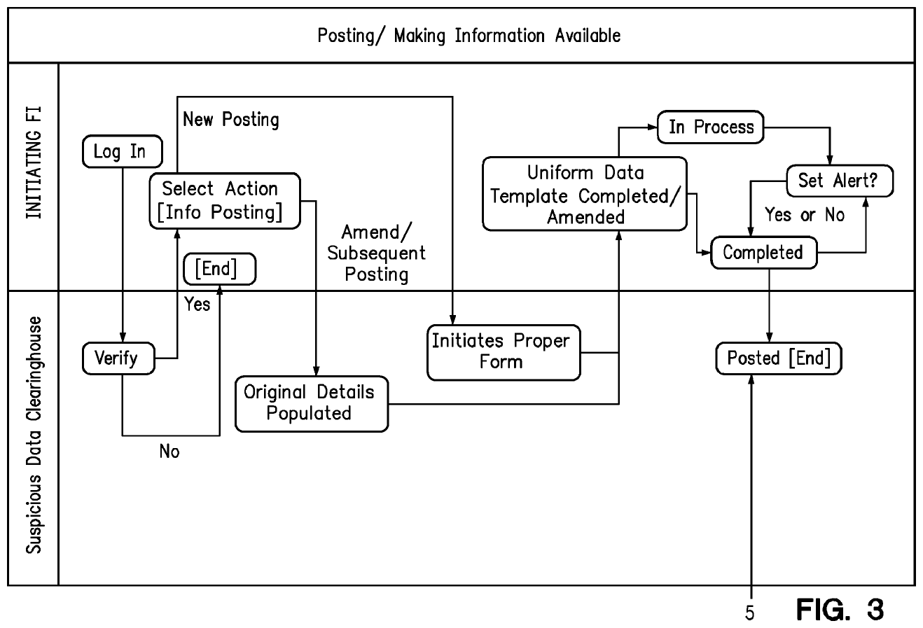

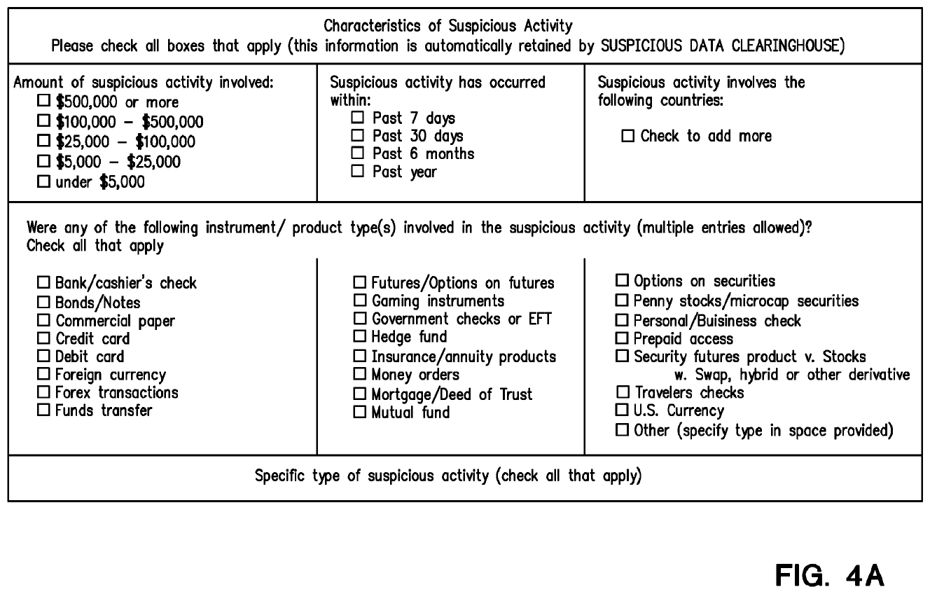

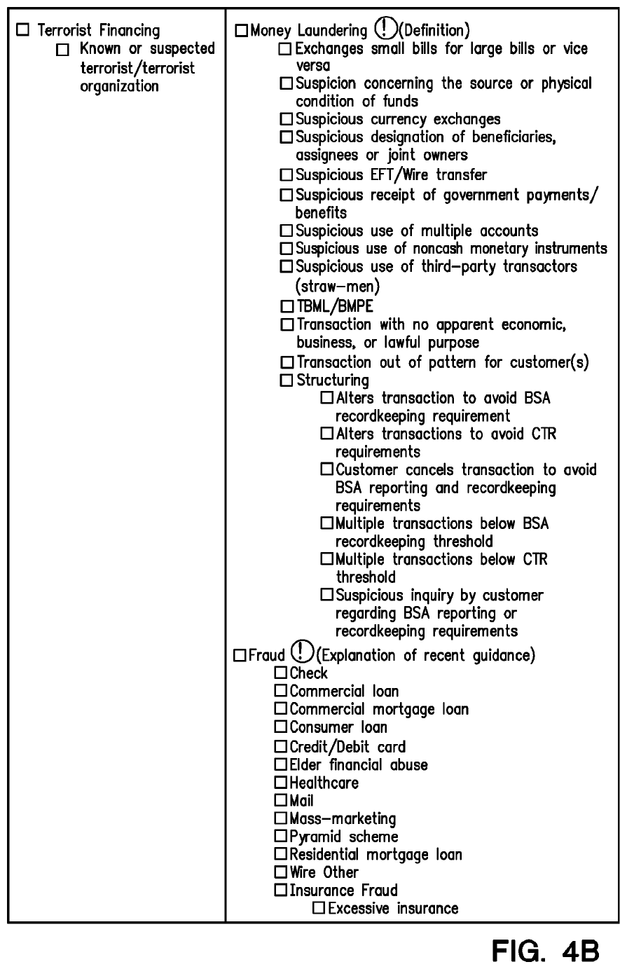

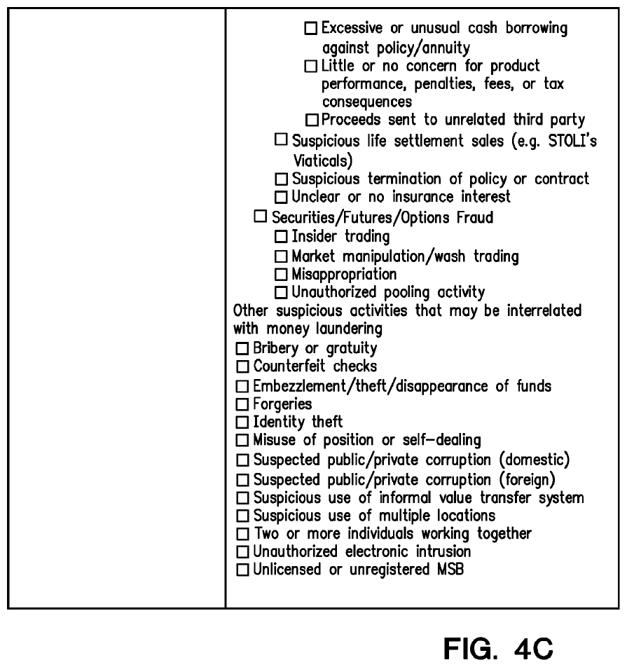

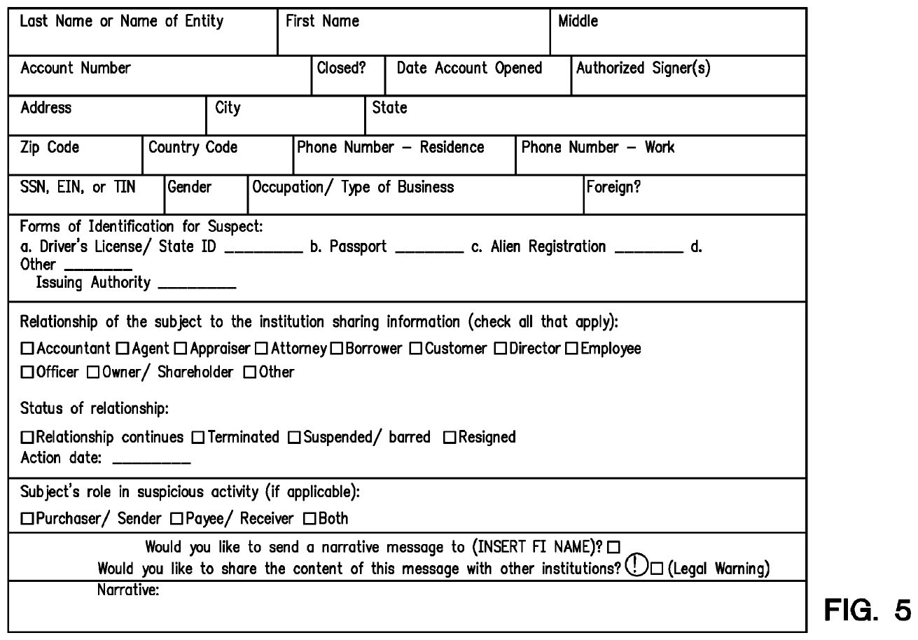

Posting and making information available to other users is the process by which financial institutions transfer information to the SDC, FIG. 3. The first step includes populating templates with information about the characteristics of the suspicious activity, FIGS. 4A, 4B and 4C, such as dates, locations, type of conduct, and amount of money involved. Next, the user provides specific details about the conduct, FIG. 5, such as names of involved entities, account numbers, addresses, and a narrative description of the activity. Finally, the user determines the parties that will have access to the specific information: it may only be available internally; it may be accessible to non-affiliated institutions; or it may be accessible to non-affiliated institutions and covered by the safe harbor provision of USA PATRIOT Act section 314(b) at 5. Data transferred to SDC is encrypted, securely stored, and backed-up routinely with data integrity in compliance with section 501 of the Gramm-Leach-Bliley Act.

Characteristic information is used by the SDC to generate analytics measuring activity in real-time, such as reports about the foreign countries suspected of harboring suspicious activity or the types of fraud or money laundering occurring, i.e. mortgage fraud, trade-based money laundering, the use of straw men, or suspicious, unidentifiable beneficiaries, as well as details about the occurrence and frequency of loss generating activity.

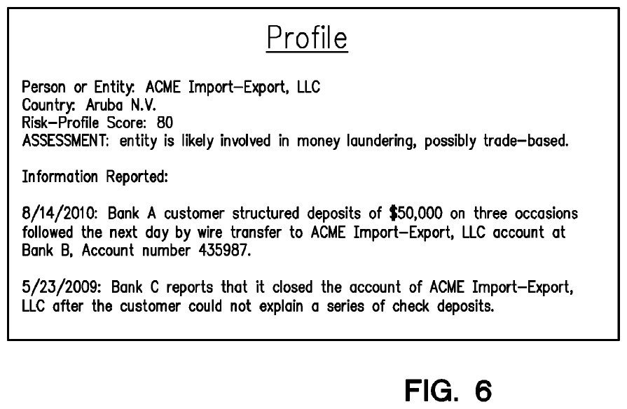

Specific information is used by the SDC to create profiles, as shown in FIG. 6. Profiles are created based on an individual person or entity name and evolve as different financial institutions post new information. SDC indexes and aggregates the information, makes it searchable, and provides a secure delivery method. For information provided to SDC as agent for 314(b) purposes, SDC ensures that the information is secured and distributed in full compliance with all regulations. Profile fields include: formula based risk score; SDC analyst assessment; and summary of detailed information reported.

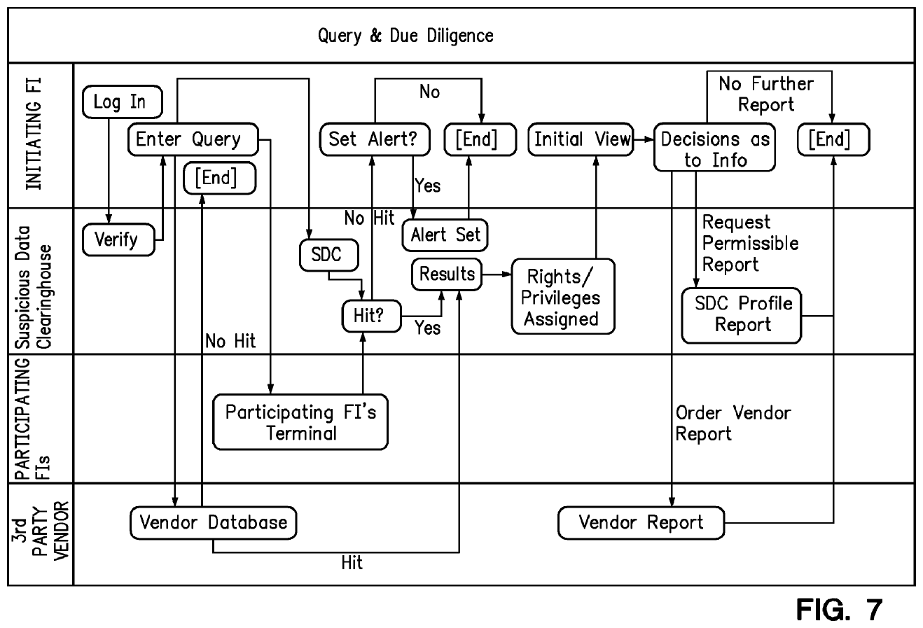

Profiles are accessible through the invention's query and due diligence function, as shown in FIG. 7. This process enables users to simultaneously search the SDC database for data in its control, data made accessible to SDC but controlled by a participating financial institution, as well as access to reports and information available from select third-party vendors.

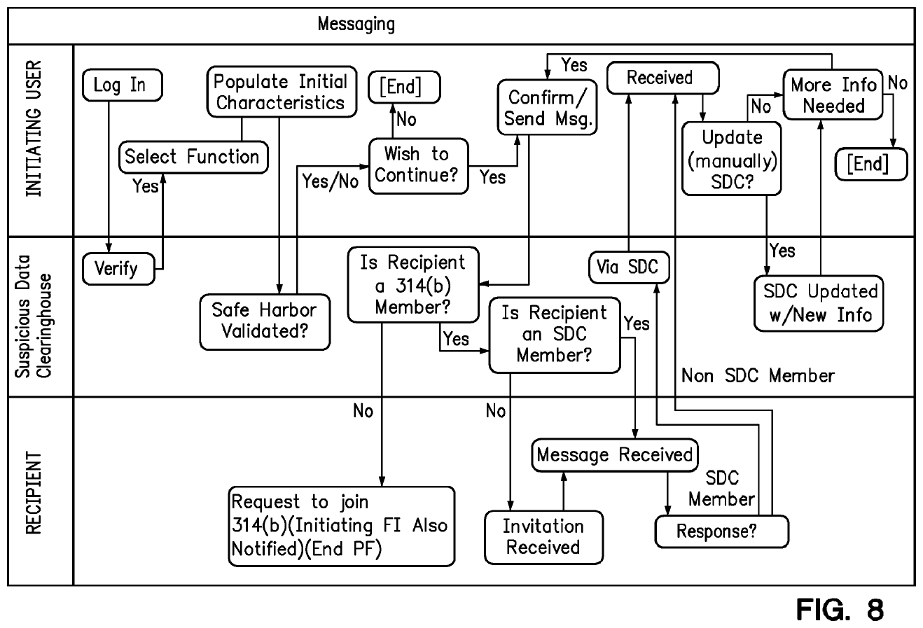

The invention also enables users to identify and send messages to counterparties at either their own or a non-affiliated institution, as shown in FIG. 8. Using a database created and maintained by SDC, users can identify persons that they would like to contact and send that person an “invitation to communicate,” as shown in FIG. 8. The request includes a simple preview of the communication automatically constructed from the users answers to the characteristic questions included in FIGS. 4A, 4B and 4C (this information is captured for analytical purposes), an instruction that USA PATRIOT Act 314(b) will cover the communication, if applicable, and also asks whether the recipient desires to communicate. The invention sends generic, formatted messages generated through SDC to the recipient's employer-based email account. If recipient desires to communicate using SDC, the invention enables recipient to electronically respond and the parties to continue exchanging information through SDC. Message exchanges using SDC involve providing characteristic and specific information. During the course of messaging, exchange users have the option of posting or making available specific information captured in the messages to the SDC.

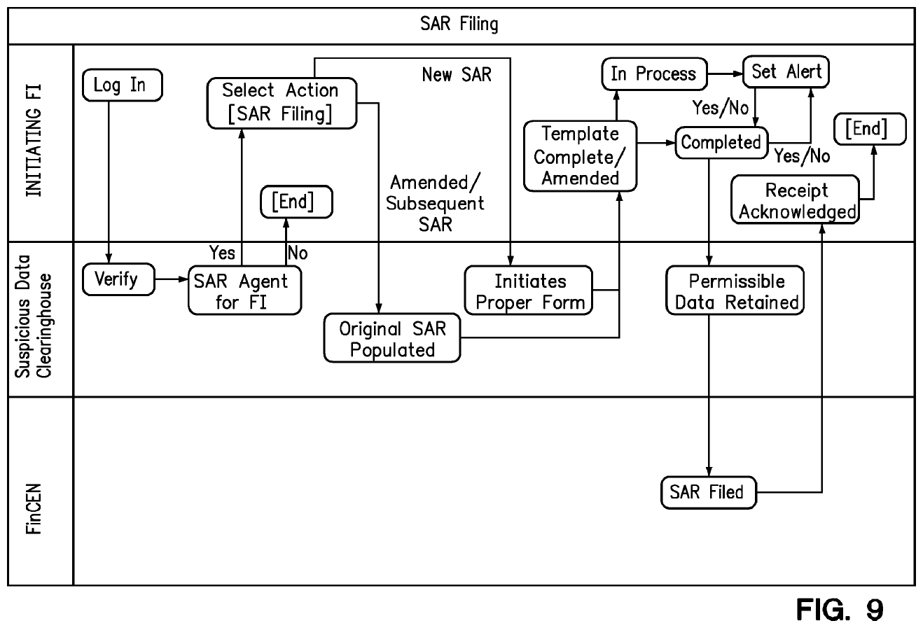

The invention enables users to prepare suspicious activity reports (SAR) for filing with FinCEN within the SDC environment, as shown in FIG. 9. The invention allows the user to populate a SAR and concurrently with filing designate certain fields for submission to the Suspicious Data Clearinghouse without disclosing to other users that a SAR has been created.

The invention leverages data flow by enabling users to set alerts for any new information received by SDC that matches the name of the person or entity provided by the user, as shown in FIG. 2, FIG. 3, FIG. 7, and FIG. 9.

### Example 1

Financial Institution 1 (FI-1) is an insurance company that offers variable annuity products to its customers. FI-1 determines that its customer, C-1, has defrauded the company by providing false information on multiple policy applications. Unfortunately for FI-1 they detected the fraudulent conduct after distributing funds to the beneficiaries of these policies via wire transfers from FI-1's account to each beneficiary's bank account at different financial institutions.

Based on this hypothetical fact pattern, the utility of the invention is demonstrated as follows. FI-1 can use the invention to connect, communicate, and share information with the financial institutions that received funds that FI-1 believes are derived from criminal conduct. To the extent FI-1 believes the transfer to the beneficiaries were designed, in part, to disguise the true origin of the fraudulently obtained funds, FI-1 can use the invention to engage in these communications under the safe harbor provision of the USA PATRIOT Act. Likewise, FI-1 can utilize the invention to post or make available information about C-1 to the SDC so that in the future other financial institution can utilize this information as part of its customer or transactional due diligence.

### Example 2

Financial Institution 2 (FI-2) maintains an account for an authorized agent of a licensed money transmitting business, Customer 2 (C-2). (In the United States, money transmitting is a licensed and regulated business. This sector of the financial industry plays an important role in enabling individuals without access to traditional banking services to send and receive funds. Typically, the money transmitting business operates as follows: the money transmitting business receives money from a customer and then, for a fee paid by the customer, transmits that money to a recipient in a place that the customer designates, often a foreign country. After the customer gives the money transmitter an amount to send to the designee, the transmitter notifies the “payer” with whom it has a contractual arrangement in the recipient country. The payer then notifies the designated recipient of the money and pays the money to the designee at the payer's office. The transmitter then remits to the payer the amount paid to the designee, plus the payer's commission. As in the example above, licensed money transmitters commonly utilize “agents” located in other cities who receive money from customers and then transfer those funds to the licensed money transmitting business. The money transmitting business is then responsible for transmitting those funds to the recipient. Typically, agents are restricted by their agency agreement and by statute from transmitting money directly. Examples of these businesses include Western Union and the U.S. Postal Service. See generally, United States v. Velastegui, 199 F.3d 590 (1999) (describing how money transmitting businesses typically operate). Given C-2's profile, the expected account activity should be limited to frequent deposits of cash and checks followed by the transfer of deposited funds into the bank account of the licensed money transmitting business. FI-2 detects a pattern of unusual transaction activity wherein C-1 appears to be depositing funds and transmitting them directly to recipients, in violation of C-2's agency agreement, and, potentially, state and federal laws requiring C-2 to be licensed. FI-2 investigates this conduct, including interviewing the accountholders, and subsequently elects to terminate the relationship with C-2.

Based on this hypothetical fact pattern, the utility of the invention is demonstrated as follows. First, during its investigation FI-1 can access any information previously posted to the SDC related to C-1. So, if C-1 engaged in similar conduct at a different financial institution, FI-1 could benefit from this knowledge in making a business decision about continuing its relationship with C-1. Next, FI-1 can use the invention to post or make available information about C-1's activity to the SDC. To the extent FI-1 determined that C-1's conduct related to money laundering, (i.e. C-1 enabled anonymous access to the financial system for their customers) FI-1 can use the invention to post and share this information under the safe harbor provision of the USA PATRIOT Act. Finally, the invention can be utilized by FI-1 to communicate with any other financial institutions potentially impacted by C-1's conduct.

Accordingly, one aspect of the present invention is a system for storage, evaluation, and transmission of information related to suspicious underlying activity that in turn is related to financial transactions. In general, the system comprises:
(1) a secure data processing center, wherein the secure data processing center accesses, receives, stores, and transmits information related to suspicious underlying activity that in turn is related to financial transactions, the secure data processing center including therein an auditing and retrieval mechanism for the information including a memory;
(2) at least one terminal or server in communication with the secure data processing center, wherein the terminal or server transmits and receives the information related to suspicious underlying activity that in turn is related to financial transactions; and
(3) means for authenticating and controlling communication between the at least one terminal or server and the secure data processing center; wherein the storage of the information in the secure data processing center modifies the state of the secure data processing center in terms of the physical state of as the memory as the result of the storage of the information.

The secure data processing center is typically accessible via a conventional desktop or laptop computer, or a conventional tablet computer. The secure data processing center typically stores information on a hard disc or other conventional memory storage device. The secure data processing center includes means for backup of the stored information and conventional security devices such as a firewall.

The means for authenticating and controlling communication can incorporate either a wired or a wireless connection. The means for authenticating and controlling communication includes security features such as encryption and typically requires the entry of both a username and a password prior to commencement of communication. The means for authenticating and controlling communication can be programmed to require that passwords be of a specified strength and reject passwords that are below that strength; the means for authenticating and controlling communication can also be programmed to require that passwords be changed at a specified interval.

The means for authenticating and controlling communication can enable some users to post information and messages, while restricting other users to only viewing analytics generated by the system.

The system can further verify that a financial institution associated with a terminal is an active participant in a statutory information sharing program intended to identify and potentially report money laundering and terrorist financing activity, as defined under Section 314(b) of the United States Patriot Act. Typically, this verification involves: (i) entry of a legal agreement appointing an entity, association of financial institutions, or other financial institution controlling and/or servicing the system as an agent of the initial financial institution for the purposes of the statutory information sharing program intended to identify and potentially report money laundering and terrorist financing activity; and (ii) matching the name of the financial institution and its intended users identified in the legal agreement with an internal list of registered institutions participating in the statutory program and their listed points of contact intended to identify and potentially report money laundering and terrorist financing activity.

Once a user is verified, the system transfers a user to a dashboard platform as shown in FIG. 2. The dashboard platform makes use of a conventional graphical user interface (GUI) as is used in the conventional Windows, Linux, or Apple operating systems and is displayed on a conventional computer screen. Typically, the dashboard platform enables a user to: (1) post information; (2) message another user; (3) perform due diligence and querying functions; (4) view analytics; (5) view alerts; and (6) prepare reports regarding suspicious activity. The GUI can enable a user to make use of another conventional program, such as a word processing program or a program for preparing and manipulating spreadsheets.

Typically, when a user posts or makes available information through the dashboard platform, a first step in entry of the information includes populating a template with information about the characteristics of the suspicious activity. This information can include, for example and not by way of limitation, such information as dates, locations, the type of conduct, and the amount of money involved. In a second step in entry of the information, the user then provides specific details about conduct relating to the suspicious activity, for example, and not by way of limitation, such details as names of involved entities, account numbers, addresses, and a narrative description of the activity. Finally, the user then determines the parties that will have access to the specific information. The information posted by a user is then utilized by the system to generate one or more analytics measuring activity in real time, for example, and not by way of limitation, reports about the foreign countries suspected of harboring suspicious activity and the types of suspicious activity involved.

Typically, specific information is used by the system to create profiles. Profiles are first created based on an individual person or entity name and are evolved as more information is entered, including, but not limited to, information posted or made available by other individuals within the same financial institution or information posted by individuals in other financial institutions to which the system has access. The system can index and aggregate the information included in profiles, make it searchable, and provide a secure delivery method for the aggregated information. The profiles can be accessed through a query and due diligence function.

The system also has the capability to send one or more messages to counterparties within the same financial institution or another financial institution to which the system has access. The system can create a database of counterparties; a user can then identify persons that they would like to contact and send that person an “invitation to communicate.” Typically, the request includes a simple preview of the communication (this information is captured for analytical purposes) and an instruction that USA PATRIOT Act 314(b) will cover the communication. The system sends formatted messages generated through SDC to the recipient's employer-based email account and their inbox on the system through the platform accessible to the recipient. Recipients respond to messages by entering information into the original message and sending a response to the originator. If the parties desire to continue communicating using the system, the invention enables the parties to electronically exchange information. Message exchanges using the system involve providing characteristic and specific information. During the course of messaging, exchange users have the option of posting specific information captured in the messages to the system.

Typically, the system enables users to prepare a Suspicious Activity Report for transmittal to a government agency monitoring such activity and have the system also retain the underlying information used to complete the report.

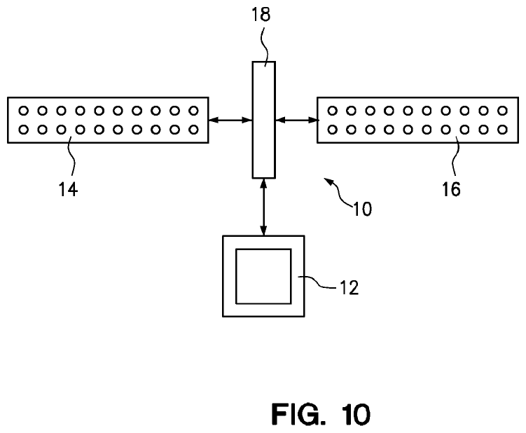

FIG. 10 shows a block diagram of the system. The system 10 includes the secure data processing center 12, two terminals 14 and 16, and a means for authenticating and controlling communication between the at least one terminal and the secure data processing center 18.

In operation, the invention includes a method wherein any officer, employee, or agent of a financial institution employs the system of the invention to voluntarily post or make information available concerning an incident of suspected fraud, money laundering, terrorist financing or other specified unlawful activity (SUA) to a central data processing unit. Typically, the information posted is protected by the safe harbor provision of the USA PATRIOT Act.sctn.314(b). Typically, the system creates one or more profiles, and the profiles are first created based on an individual person or entity name and are evolved as more information is entered or made available. Typically, the information included in profiles is indexed and aggregated. Typically, the information included in profiles is searchable. Typically, the system provides a secure delivery method for the aggregated information in profiles. Typically, the profiles are accessed through a query and due diligence function. Typically, the system sends one or more messages to counterparties within the same financial institution or another financial institution to which the system has access. Typically, the system enables a user to prepare a Suspicious Activity Report for transmittal to a government agency monitoring such activity and have the system also retain the underlying information used to complete the report.

Another application of the system of the present invention is a method wherein any officer, employee, or agent of a financial institution employs the system of the invention to voluntarily post or make available information concerning an incident of suspected fraud, money laundering, terrorist financing or other specified unlawful activity (SUA) to a secure data processing center. Typically, the information posted or made available is protected by the safe harbor provision of the USA PATRIOT Act.sctn.314(b). Typically, any information posted to a secure data processing center will be retained for purposes of compliance with laws, rules, and regulations concerning the voluntary sharing of information related to suspected fraud, money laundering, terrorist financing and other SUA. Typically, information described in this method that is provided or made available by multiple financial institutions is aggregated and analyzed to develop profiles and establish trending. Typically, information described in this method that is provided or made available by multiple financial institutions is used to create profiles concerning persons and entities suspected of involvement in an incident of fraud, money laundering, terrorist financing and other SUAs. Typically, information described in this method is used to alert other financial institutions about a person or entity suspected of involvement in an incident of suspected fraud, money laundering, terrorist financing and other SUAs.

Yet another application of a system according to the present invention is a method wherein any officer, employee, or agent of a financial institution employs the system of the present invention to voluntarily connect, communicate, and share information concerning suspected fraud, money laundering, terrorist financing and other SUAs, with other officers, employees, or agents of the same financial institution, affiliated financial institutions, or non-affiliated financial institutions. Typically, information concerning the characteristics of an incident of suspected fraud, money laundering, terrorist financing and other SUAs is contributed to a secure data processing center. Typically, specific information regarding the identity of persons or entities suspected of involvement in an incident of alleged fraud, money laundering, terrorist financing and other SUAs is contributed or made available to a secure data processing center. Typically, any information contributed to a secure data processing center is retained for proprietary purposes. Typically, (i) information concerning the characteristics of an incident of suspected fraud, money laundering, terrorist financing and other SUAs and (ii) specific information regarding the identity of persons or entities suspected of involvement in an incident of alleged fraud, money laundering, terrorist financing and other SUAs is analyzed. Typically, the information is used to create profiles concerning persons and entities suspected of involvement in an incident of suspected fraud, money laundering, or terrorist financing. Typically, the information is used to alert another officer, employee, or agent of the same financial institution or an affiliated financial institution about a person or entity suspected of involvement in an incident of suspected fraud, money laundering, terrorist financing and other SUAs. Typically, the information contributed to a secure data processing center is accessed and utilized for querying, data mining, trending, and alert purposes. Typically, any officer, employee, or agent of a financial institution can identify and contact other officers, employees, or agents of a non-affiliated financial institution, for the purpose of communicating and sharing information concerning suspected fraud, money laundering, terrorist financing and other SUAs. Typically, non-affiliated financial institutions communicate and voluntarily share information concerning suspected fraud, money laundering, terrorist financing and other SUAs pursuant to laws, rules, and regulations granting said financial institutions immunity from civil liability. Typically, non-affiliated financial institutions can identify and contact other financial institutions eligible to participate in the voluntary sharing of information concerning suspected fraud, money laundering, terrorist financing and other SUAs under laws, rules, and regulations granting said financial institutions immunity from civil liability; non-affiliated financial institutions also communicate and share information concerning matters and/or incidents unrelated to fraud, money laundering, terrorist financing or other SUAs. In this method, typically, a financial institution can identify and contact another financial institution. In this method, typically, non-affiliated financial institutions communicating and sharing information contribute information concerning suspected fraud, money laundering, terrorist financing and other SUAs to a secure data processing center. The financial institutions can contribute information concerning the characteristics of an incident of suspected fraud, money laundering, terrorist financing and other SUAs. The financial institutions can also contribute specific information regarding the identity of persons or entities suspected of involvement in an incident of suspected fraud, money laundering, terrorist financing and other SUAs. In the method, any information contributed to a secure data processing center can be retained for proprietary purposes. The information can be retained for purposes of compliance with laws, rules, and regulations concerning the voluntary sharing of information related to suspected fraud, money laundering, terrorist financing and other SUA. In this method, the information provided can be analyzed. The information can be used to create profiles concerning persons and entities suspected of involvement in an incident of suspected fraud, money laundering, or terrorist financing. The information can be used to alert another officer, employee, or agent of the same financial institution or an affiliated financial institution about a person or entity suspected of involvement in an incident of suspected fraud, money laundering, terrorist financing and other SUAs. Any information contributed to a secure data processing center can be accessed by a non-affiliated financial institution.

The system of the present invention can also be used to prepare specific reports relating to the activities and patterns of suspected parties, which may include a financial institution's customers, counter-parties or other third parties.

Although the invention has been particularly described with respect to the United States PATRIOT Act and regulations promulgated under the United States PATRIOT ACT, the systems and methods of the present invention are applicable and can be readily adapted to other jurisdictions, such as, but not limited to the European Union, where financial reporting is regulated by EU Directive 2005/60/EC and other regulations, the United Kingdom, where financial reporting is regulated by various legislation, including the Terrorism Act 2000, the Anti-terrorism, Crime and Security Act 2001, the Proceeds of Crime Act 2002, and the Serious Organised Crime and Police Act 2005, and other jurisdictions where analogous legislation and regulations are in force. The systems and methods of the present invention can be customized to conform to and provide appropriate reports with respect to such jurisdictions.

### Advantages of the Invention

The present invention provides an efficient and robust system to identify, track, prevent and report potentially improper financial activity, such as financial activity associated with criminal activity and support of terrorism, communicate such improper financial activity to others involved with tracking and reporting such activity, and aggregate information to prepare suitable reports. The system of the present invention enables users to analyze and break down information to discover patterns associated with improper financial activity.

The present invention possesses industrial applicability as a system capable of identifying, tracking, preventing and reporting on potential improper financial activity.

Unless defined otherwise, the meanings of all technical and scientific terms used herein are those commonly understood by one of ordinary skill in the art to which this invention belongs. One of ordinary skill in the art will also appreciate that any methods and materials similar or equivalent to those described herein can also be used to practice or test this invention.

The publications and patents discussed herein are provided solely for their disclosure prior to the filing date of the present application. Nothing herein is to be construed as an admission that the present invention is not entitled to antedate such publication by virtue of prior invention. Further the dates of publication provided may be different from the actual publication dates which may need to be independently confirmed.

All the publications cited are incorporated herein by reference in their entireties, including all published patents, patent applications, and literature references, as well as those publications that have been incorporated in those published documents. However, to the extent that any publication incorporated herein by reference refers to information to be published, applicants do not admit that any such information published after the filing date of this application to be prior art.

As used in this specification and in the appended claims, the singular forms include the plural forms. For example the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

1. A centralized and secure electronic system to identify, track, and monitor suspicious financial activity of a person or an entity across a plurality of non-affiliated financial institutions and support increased, efficient, and robust sharing of information among the plurality of non-affiliated financial institutions about the suspicious financial activity of the person or the entity, the system comprising:
a secure data processing center configured to, via a global computer network,
verify one or more users at each one of the non-affiliated financial institutions, wherein the verified one or more users are permitted to access the secure data processing center and communicate with other verified users through the secure data processing center,
create a profile of a person or an entity associated with suspicious financial activity, wherein the profile comprises analytics measuring financial activity,
facilitate secure communications with a dashboard platform implemented on a first verified user's terminal, wherein the dashboard platform comprises a graphical user interface to allow the first verified user to post information about the person or the entity with suspicious financial activity, message a second verified user at a non-affiliated financial institution, view information in the profile of the person or the entity associated with suspicious financial activity, view an alert regarding the person or the entity associated with suspicious financial activity, and prepare a report regarding suspicious financial activity for filing with FinCEN.

2. The system of claim 1, wherein the verified one or more users are permitted to communicate, through the secure data processing center, with a participant in a statutory information sharing program as defined under § 314(b) of the United States Patriot Act.

3. The system of claim 2, wherein the secured data processing center is configured to verify a financial institution associated with the participant is an active participant in the statutory information sharing program as defined under § 314(b) of the United States Patriot Act.

4. The system of claim 3, wherein the secure data processing center is further configured to obtain from FinCEN, via the global computer network, information regarding active participants in the statutory information sharing program as defined under § 314(b) of the United States Patriot Act.

5. The system of claim 1, wherein the suspicious activity report comprises a populated template, the secure data processing center is further configured to transmit the suspicious activity report with FinCEN.

6. The system of claim 1, wherein the secure data processing center is further configured to update the profile of the person or the entity associated with suspicious financial activity as information is received by the secure data processing center.

7. The system of claim 1, wherein the profile includes a risk score.

8. The system of claim 1, wherein information distributed by the secure data processing center is secured in compliance with U.S. Government regulations.

9. The system of claim 1, further comprising a repository of financial transactions involving the person or the entity with suspicious financial activity.

10. The system of claim 1, wherein the alert regarding the person or the entity associated with suspicious financial activity comprises suspicious financial activity occurring at a second, non-affiliated financial institution.

11. A method to identify, track, and monitor suspicious financial activity of a person or an entity across a plurality of non-affiliated financial institutions electronically connected to a global computer network and support increased, efficient, and robust sharing of information, among the plurality of non-affiliated financial institutions about the suspicious financial activity of the person or the entity, the method comprising the steps of:
verifying, via a centralized, secure data processing center electronically connected to the global computer network and the plurality of non-affiliated financial institutions, a first user at a first financial institution, wherein the verified first user is permitted to access the secure data processing center and communicate with a second user at second financial institution not affiliated with the first financial institution,
creating a profile of a person or an entity associated with suspicious financial activity, wherein the profile comprises analytics measuring financial activity,
facilitating secure communications between the secure data processing center and a dashboard platform of the first verified user, wherein the dashboard platform comprises a graphical user interface,
alerting the first verified user, via the dashboard platform, of a suspicious financial activity associated with the person or the entity occurring at the second financial institution, and
sending, via the dashboard platform, information in the profile of the person or the entity associated with suspicious financial activity to the first verified user.

12. The method of claim 11, further comprising the step of receiving, via a dashboard platform of the second user, a post or report regarding the suspicious financial activity associated with the person or the entity occurring at the second financial institution.

13. The method of claim 12, further comprising the step of filing, via the secure data processing center, the report with FinCEN.

14. The method of claim 12, wherein the second financial institution is a participant in a statutory information sharing program as defined under § 314(b) of the United States Patriot Act.

15. The method of claim 14, further comprising the step of verifying active participation of the second financial institution in the statutory information sharing program as defined under § 314(b) of the United States Patriot Act.

16. The method of claim 15, wherein the step of verifying active participation comprises the step of obtaining from FinCEN, via the global computer network, information regarding active participants in the statutory information sharing program as defined under § 314(b) of the United States Patriot Act.

17. The method of claim 12, wherein the report comprises a populated template.

18. The method of claim 11, further comprising the step of updating the profile of the person or the entity associated with suspicious financial activity as information is acquired from one or more financial institutions in the plurality of non-affiliated financial institutions.

19. The method of claim 18, wherein the profile includes a risk score.

20. The method of claim 11, wherein the first financial institution is not affiliated with the second financial institution and information sharing between the first financial institution and the second financial institution is facilitated by the secure data processing center in compliance with the statutory information sharing program as defined under § 314(b) of the United States Patriot Act.
